(19) United States
(12) Patent Application Publication
(10) Pub. No.: US 2012/0244367 A1
(43) Pub. Date: Sep. 27, 2012

(54) DISPLAY APPARATUS AND METHOD OF MANUFACTURING THE SAME

(76) Inventors: Kwanyoung Han, Yongin-City (KR); Jun-Young Ko, Yongin-City (KR)

(21) Appl. No.: 13/334,943

(22) Filed: Dec. 22, 2011

(30) Foreign Application Priority Data
Mar. 25, 2011 (KR) 10-2011-0027115

(51) Int. Cl. B32B 38/10; B32B 27/30; B32B 27/06; B32B 37/12

(52) U.S. Cl. 428/483; 156/306.6; 156/247; 156/249; 156/64; 428/522

(57) ABSTRACT

A method of manufacturing a display device includes providing an adhesive layer between a display panel and a polarization member and adhering the display panel and the polarization member to each other using the adhesive layer. The adhesive layer includes an adhesive material having a first adhesion strength at room temperature and a second adhesion strength at a temperature higher than room temperature. The first adhesion strength is higher than the second adhesion strength. A display device includes a display panel, a polarization member disposed on a surface of the display panel, and the adhesive layer interposed between the display panel and the polarization member.

### BACKGROUND

1. Field

Example embodiments relate to a display device and a method of manufacturing the same.

2. Description of the Related Art

A display device may be a device capable of displaying desired data using a display panel. Various data, such as characters, still images, or moving images, may be displayed using the display panel. Also, display devices may be fabricated to have various sizes and thicknesses according to the type of an electronic device applied thereto.

### SUMMARY

According to an embodiment, there is provided a method of manufacturing a display device, including providing an adhesive layer between a display panel and a first polarization member, and adhering the display panel and the first polarization member to each other using the adhesive layer. The adhesive layer includes an adhesive material that has a first adhesion strength at a first temperature and a second adhesion strength at a second temperature, the second temperature being higher than the first temperature, and the first adhesion strength being higher than the second adhesion strength.

Providing the adhesive layer may include adhering the adhesive layer to a surface of the first polarization member that faces the display panel.

Providing the adhesive layer may include adhering the adhesive layer to a surface of the display panel that faces the first polarization member.

The adhesive material may include one of an acrylic copolymer and a modified rosin ester.

The adhesive layer may include a plurality of adhesive layers including a first adhesive layer that includes the adhesive material having the first adhesion strength at the first temperature and the second adhesion strength at the second temperature. Adhering the display panel and the first polarization member to each other may be carried out such that the first adhesive layer faces the display panel.

The adhesive layer may include a second adhesive layer, the second adhesive layer including an acrylic adhesive.

The adhesive layer may include a third adhesive layer, the third adhesive layer including a silicon-treated polyethylene terephthalate film.

The first adhesive layer, second adhesive layer and the third adhesive layer may be disposed such that the first adhesive layer faces the display panel, the second adhesive layer faces the first polarization member and the third adhesive layer is between the first adhesive layer and the second adhesive layer.

The method may further include separating the first polarization member from the display panel by heating the adhesive layer up to the second temperature.

The method may further include adhering the display panel and a second polarization member to each other using the adhesive material.

After adhering the display panel and the first polarization member to each other using the adhesive layer, the method may further include determining whether the display panel and the first polarization member have been defectively adhered to each other, and, when the determining indicates that the display panel and the first polarization member have been defectively adhered to each other, separating the first polarization member from the display panel by heating the adhesive layer up to the second temperature and adhering the display panel and a second polarization member to each other using the adhesive material.

The display panel may have an encapsulation structure including at least one of an inorganic layer and an organic layer.

The adhering of the display panel and the first polarization member to each other using the adhesive layer may be carried out such that the adhesive layer faces the inorganic layer or organic layer of the encapsulation structure.

According to an embodiment, there is provided a display device that includes a display panel, a polarization member disposed on a surface of the display panel; and an adhesive layer interposed between the display panel and the polarization member. The adhesive layer includes an adhesive material that has a first adhesion strength at room temperature and a second adhesion strength at a temperature higher than the room temperature. The first adhesion strength is higher than the second adhesion strength.

The adhesive material may include one of an acrylic copolymer and a modified rosin ester.

The adhesive layer may include a plurality of adhesive layers including a first adhesive layer that includes the adhesive material having the first adhesion strength at the first temperature and the second adhesion strength at the second temperature. The first adhesive layer may face the display panel.

The adhesive layer may include a second adhesive layer, the second adhesive layer including an acrylic adhesive.

The adhesive layer may include a third adhesive layer, the third adhesive layer including a silicon-treated polyethylene terephthalate film.

The first adhesive layer may face the display panel, the second adhesive layer may face the first polarization member and the third adhesive layer may be between the first adhesive layer and the second adhesive layer.

The display panel may have an encapsulation structure including at least one of an inorganic layer and an organic layer and the first adhesive layer may face the encapsulation structure.

### BRIEF DESCRIPTION OF THE DRAWINGS

The embodiments will become more apparent to those of ordinary skill in the art by describing in detail exemplary embodiments with reference to the attached drawings, in which:

FIGS. 1A and 1B illustrate schematic sectional views of a display panel according to embodiments;

FIGS. 2, 3A, 3B, 4, and 5 illustrate schematic sectional views of stages in a method of manufacturing a display device and the display device fabricated thereby according to embodiments;

FIGS. 6A, 6B, 7, and 8 illustrate schematic sectional views of stages in a method of manufacturing a display device and the display device fabricated thereby according to other embodiments; and

FIGS. 9A, 9B, 10, and 11 illustrate schematic sectional views of stages in a method of manufacturing a display device and the display device fabricated thereby according to other embodiments.

These figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural members may be reduced or exaggerated for clarity. The use of similar or identical reference numbers in the various drawings is intended to indicate the presence of a similar or identical member or feature.

### DETAILED DESCRIPTION

Korean Patent Application No. 10-2011-0027115, filed on Mar. 25, 2011, in the Korean Intellectual Property Office, and entitled: “Display Apparatus and Method of Manufacturing the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or member is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like members throughout. In the drawings, the thicknesses of layers and regions are exaggerated for clarity.

It will be understood that, although the terms “first”, “second”, etc. may be used herein to describe various members, components, regions, layers and/or sections, these members, components, regions, layers and/or sections should not be limited by these terms. These terms are only used to distinguish one member, component, region, layer or section from another member, component, region, layer or section. Thus, a first member, component, region, layer or section discussed below could be termed a second member, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, members and/or components, but do not preclude the presence or addition of one or more other features, integers, steps, operations, members, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of features illustrated herein but are to include deviations in shapes that result, for example, from manufacturing. Thus, the features illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Display panels according to example embodiments will now be described. The display panels may be used as a part of a display device according to embodiments.

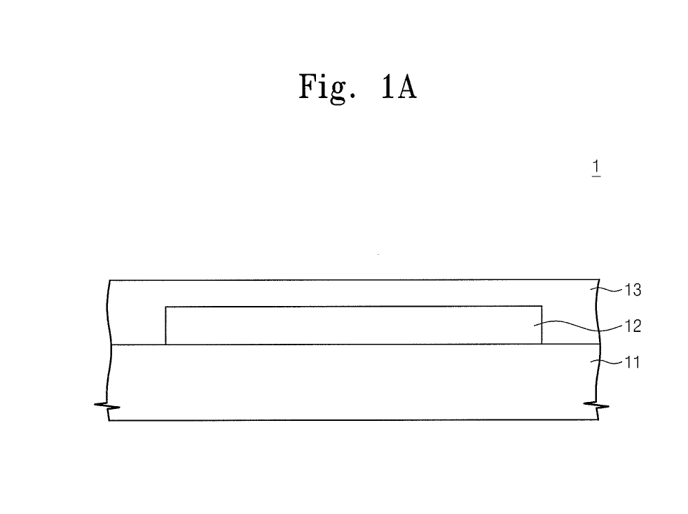

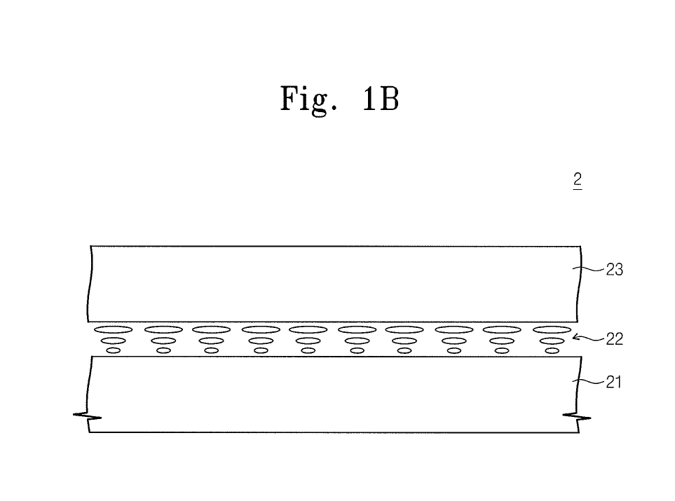

FIGS. 1A and 1B illustrate schematic sectional views of a display panel according to embodiments.

Referring to FIG. 1A, a display panel 1 may be an organic light emitting display panel. The display panel 1 may include a substrate 11 (including a pixel region and a non-pixel region defined around the pixel region), an organic light emitting diode (OLED) array 12 (disposed on the pixel region), and an encapsulation layer 13 (disposed on the substrate 11 provided with the OLED array 12).

The substrate 11 may be an opaque or transparent substrate. For example, the substrate 11 may be a silicon substrate, a glass substrate, or a flexible plastic substrate.

The OLED array 12 may include a first electrode, a second electrode, and an organic emission layer (EML) interposed between the first and second electrodes. The OLED array 12 may include at least one driving device and/or at least one switching device; and the driving and switching devices of the OLED array 12 may be realized using thin film transistor (TFT).

The encapsulation layer 13 may include at least one of an organic layer and an inorganic layer. For example, the encapsulation layer 13 may include at least one organic layer and at least one inorganic layer alternately stacked. Alternatively, the encapsulation layer 13 may be a glass substrate, a plastic substrate, or a metal substrate.

After the OLED array 12 is formed on the substrate 11, the encapsulation layer 13 may be formed on the substrate 11 to protect the OLED array 12.

Referring to FIG. 1B, a display panel 2 may be a liquid crystal display (LCD) panel. The display panel 2 may include an array substrate 21 including a plurality of pixels, an opposite substrate 23 disposed opposite the array substrate 21, and a liquid crystal (LC) layer 22 interposed between the array substrate 21 and the opposite substrate 23.

Each of the array substrate 21 and the opposite substrate 23 may be a transparent substrate, such as a glass substrate or plastic substrate. Each of the pixels of the array substrate 21 may include a TFT and a pixel electrode. The opposite substrate 23 may include red (R), green (G), and blue (B) pixels corresponding to each of the pixels and a common electrode (not shown) disposed on the R, G, and B pixels opposite the pixel electrode.

The LC layer 22 may include a liquid crystal material whose orientation can be changed by an electric field generated between the pixel electrode and the common electrode. For example, the LC layer 22 may exhibit an optical property (e.g., an optical transmittance) dependent on an electric field generated between the pixel electrode and the common electrode.

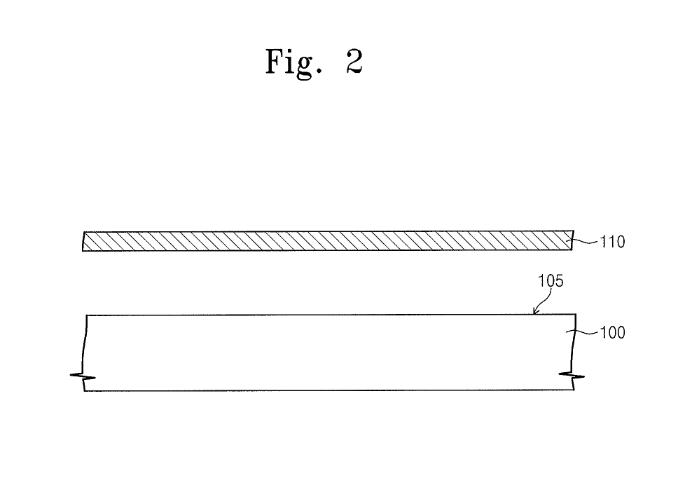

Hereinafter, a display device according to embodiments will be described with reference to FIGS. 2, 3A, 3B, 4, and 5. FIGS. 2, 3A, 3B, 4, and 5 illustrate schematic sectional views of stages in a method of manufacturing a display device and the display device fabricated thereby according to embodiments.

Referring to FIG. 2, the above-described display panel 100 may be prepared. Also, a polarization member 110 (to be subsequently adhered to a surface of the display panel 100) may be prepared. The polarization member 110 may be adhered to an emission surface 105 of the display panel 100. In some embodiments, the polarization member 110 may be adhered to a non-emission surface of the display panel 100. The polarization member 110 may prevent scattered reflection from the display panel 100. In other embodiments, the polarization member 110 may be used to polarize light in a specific direction. The polarization member 110 may be selected according to the type of the display panel 100. The polarization member 110 may be prepared as a film type.

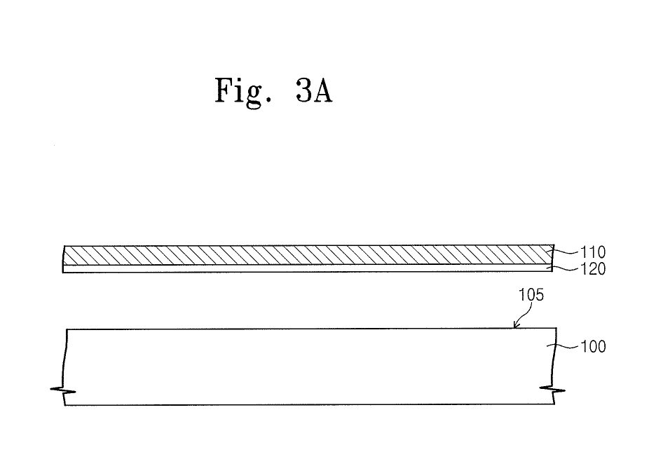

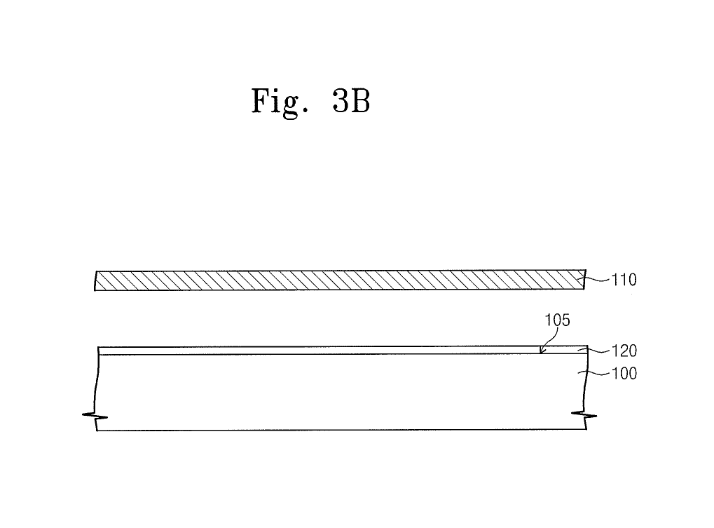

Referring to FIGS. 3A and 3B, an adhesive layer 120 may be provided between the display panel 100 and the polarization member 110. The adhesive layer 120 may include a first adhesive material. The first adhesive material may be a material having predetermined adhesion strength. Herein, the term “adhesion strength” may refer to a degree of strength by which an adhesive material is adhered to a target material. For example, the term “adhesion strength” may indicate a strength that is required to strip the adhesive material from a surface of the target material by pulling in a direction of 180°. The first adhesive material may have a first adhesion strength when measured at a first temperature and a second adhesion strength when measured at a second temperature higher than the first temperature. The first adhesion strength may be greater than the second adhesion strength. The first temperature may be room temperature. The first adhesive material may contain one of an acrylic copolymer and a modified rosin ester.

Referring to FIG. 3A, the adhesive layer 120 may be adhered to a surface of the polarization member 110 disposed facing the display panel 100. For example, the adhesive layer 120 may be provided as a film type and may be adhered to the polarization member 110. The adhesive layer 120 may be formed by coating the first adhesive material onto the surface of the polarization member 110 disposed facing the display panel 100.

Referring to FIG. 3B, the adhesive layer 120 may be adhered to an emission surface 105 of the display panel 100 disposed facing the polarization member 110. For example, the adhesive layer 120 may be provided as a film type and adhered to the display panel 100. The adhesive layer 120 may be formed by coating the first adhesive material to the emission surface 105 disposed facing the polarization member 110.

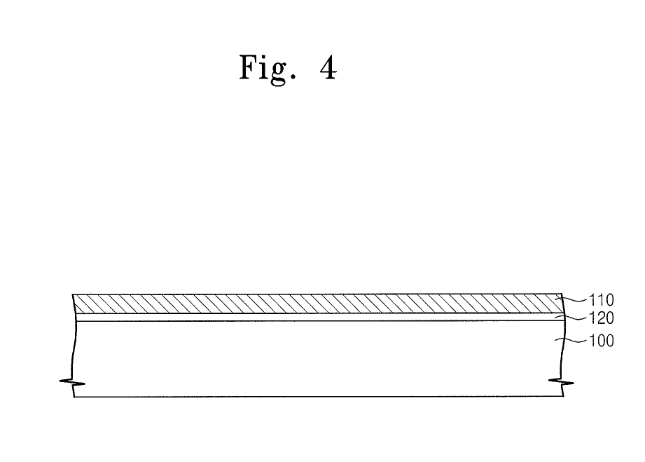

Referring to FIG. 4, the display panel 100 and the polarization member 110 may be adhered to each other using the adhesive layer 120. After the polarization member 110 is aligned with the display panel 100, the polarization member 110 may be adhered to the display panel 100.

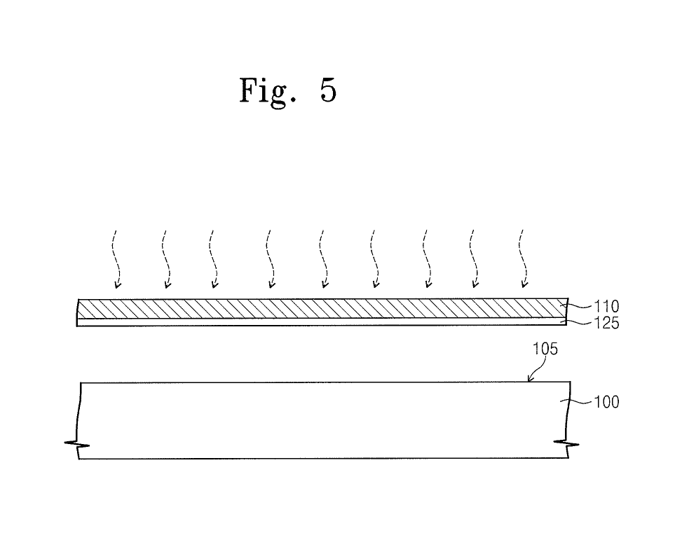

A rework process will now be described with reference to FIG. 5. During the manufacture of a display device, the polarization member 110 may be misaligned from the display panel 100. The polarization member 110 and the display panel 100 may be defectively adhered to each other. For example, bubbles may be generated at a contact surface between the polarization member 110 and the display panel 100. In this case, a rework process of separating the polarization member 110 from the display panel 100 and re-adhering the polarization member 110 to the display panel 100 may be performed.

During the rework process, the adhesive layer 120 may be heated up to a predetermined temperature. The temperature (hereinafter, heating temperature) may be higher than room temperature. Due to the heating of the adhesive layer 120, the adhesion strength of the adhesive layer 120 may be reduced, and the polarization member 110 may be easily removed from the display panel 100. Thus, damage to the display panel 100 may be prevented during the rework process. Even if the polarization member 110 is adhered onto a thin-film encapsulation layer made of an organic layer and/or inorganic layer, an unintended peeling of the encapsulation layer may be prevented during the rework process, due to the reduction of the adhesion strength of the adhesive layer 120. The heating temperature of the rework process may be selected within such a range as to reduce the tensile force of the adhesive layer 120 to about 1N/inch or less. For example, the heating temperature may range from about 50 to 100° C. In certain embodiments, the heating temperature may range from about 70 to 100° C. When the temperature is about 70° C., it may be possible to reduce the adhesion strength of the adhesive layer 120 by 90%, compared with an adhesive layer 120 measured at room temperature. After the polarization member 110 is separated from the display panel 100, an adhesive layer 125 may remain on the surface of the polarization member 110.

Afterwards, processes described with reference to FIGS. 2 through 4 may be repeated to adhere the polarization member 110 onto the display panel 100. For example, if one polarization member 110 is defective, another polarization member may be adhered to the display panel 100

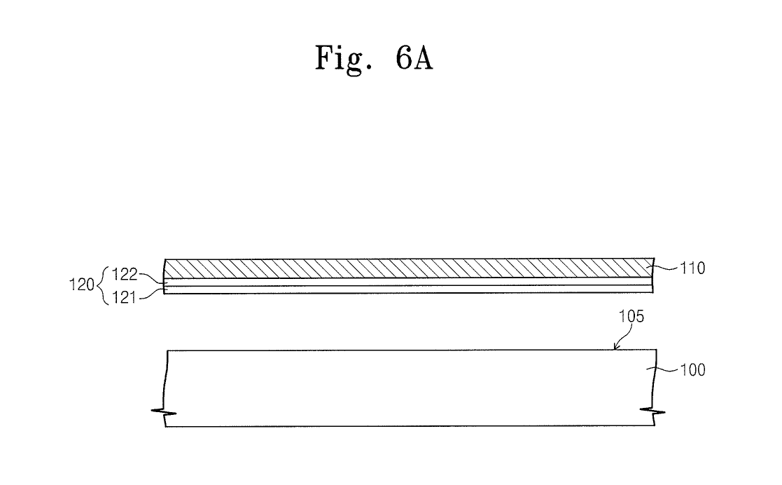

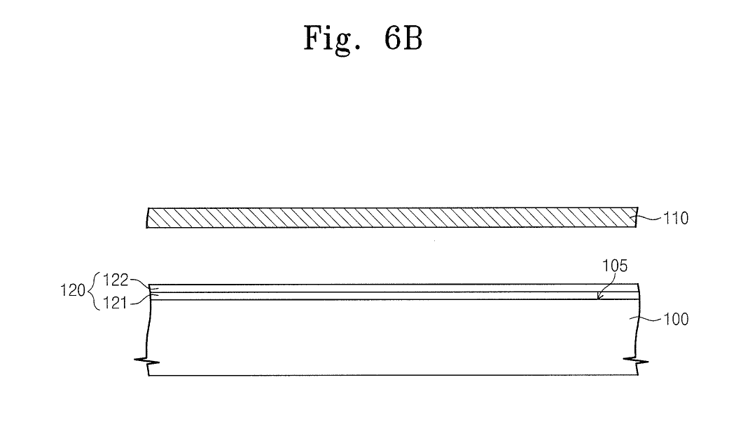

A method of manufacturing a display device according to another embodiment will now be described with reference to FIGS. 6A, 6B, 7, and 8. FIGS. 6A, 6B, 7, and 8 illustrate schematic sectional views of stages in a method of manufacturing a display device and the display device fabricated thereby according to other embodiments. Hereinafter, a description of the same or about the same components as in the previous embodiments will not be repeated or will be briefly provided.

Referring to FIGS. 6A and 6B, an adhesive layer 120 may be provided between the display panel 100 and the polarization member 110. The adhesive layer 120 may include a first adhesive layer 121 (having a first adhesive material) and a second adhesive layer 122 (having a second adhesive material). The first adhesive material may be a material having predetermined adhesion strength. The adhesion strength of the first adhesive material measured at room temperature may be higher than the adhesion strength of the first adhesive material measured at a temperature higher than the room temperature. The first adhesive material may contain one of an acrylic copolymer and a modified rosin ester. The second adhesive material may be an adhesive material, the adhesion strength of which hardly or minutely varies according to temperature. For example, the second adhesive material may be an acrylic adhesive.

Referring to FIG. 6A, the adhesive layer 120 may be adhered to the surface of the polarization member 110 disposed facing the display panel 100. For example, the adhesive layer 120 may be provided as a film type. Alternatively, after the second adhesive layer 122 is coated onto the polarization member 110, the first adhesive layer 121 may be coated onto the second adhesive layer 122.

Referring to FIG. 6B, the adhesive layer 120 may be adhered to the emission surface 105 of the display panel 100 disposed facing the polarization member 110. For example, the adhesive layer 120 may be provided as a film type. Alternatively, after the first adhesive layer 121 is coated onto the emission surface 105, the second adhesive layer 122 may be coated onto the first adhesive layer 121.

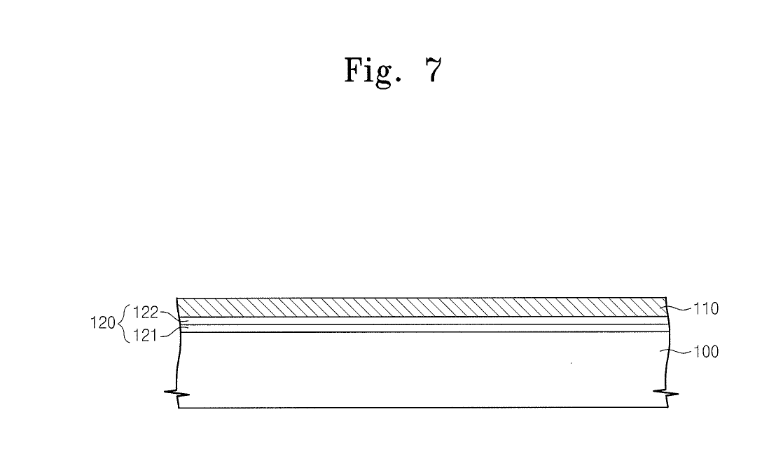

Referring to FIG. 7, the display panel 100 and the polarization member 110 may be adhered to each other using the adhesive layer 120. After the polarization member 110 is aligned with the display panel 100, the polarization member 110 may be adhered to the display panel 100.

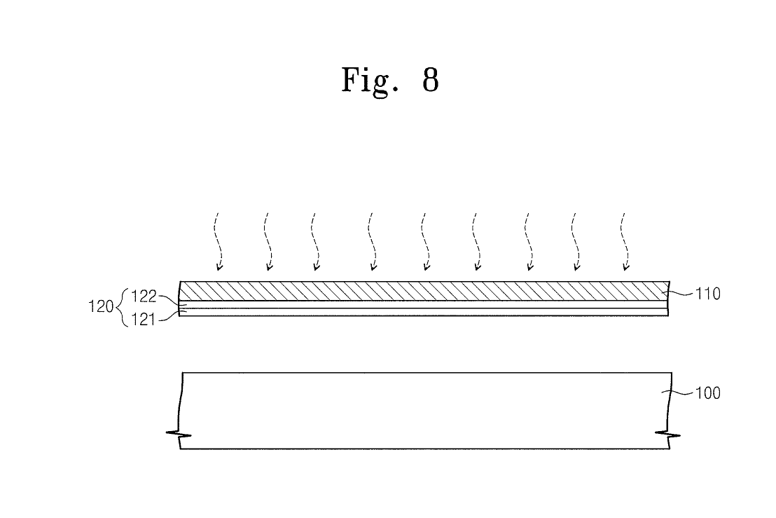

A rework process will now be described with reference to FIG. 8.

Referring to FIG. 8, the adhesive layer 120 may be heated up to a predetermined temperature. The temperature (hereinafter, heating temperature) may be higher than room temperature. Due to the heating of the adhesive layer 120, the adhesion strength of the first adhesive layer 121 may be reduced. In some embodiments, the adhesion strength of the second adhesive layer 122 may hardly or minutely vary according to the temperature of the heating step. Accordingly, damage to the display panel 100 may be prevented, and the polarization member 110 may be easily removed from the display panel 100. The temperature of the adhesive layer 120 in the heating step may be selected within such a range as to reduce the adhesion strength of the first adhesive layer 121. For example, the temperature may range from about 50 to 100° C. In some embodiments, the temperature may range from about 70 to 100° C.

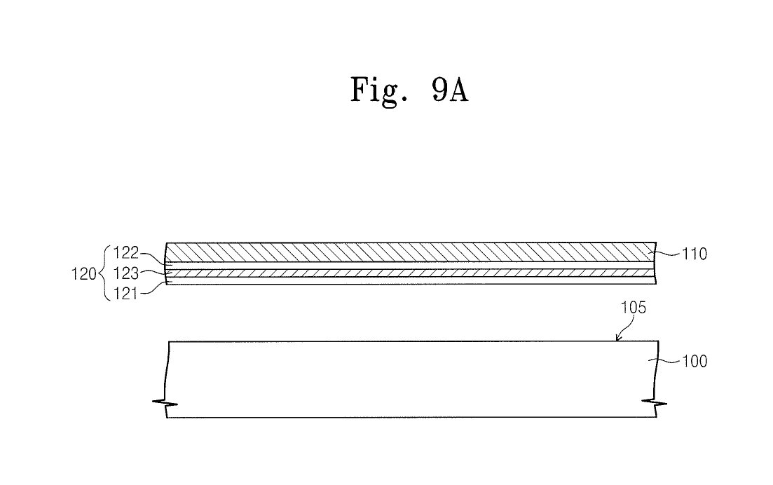

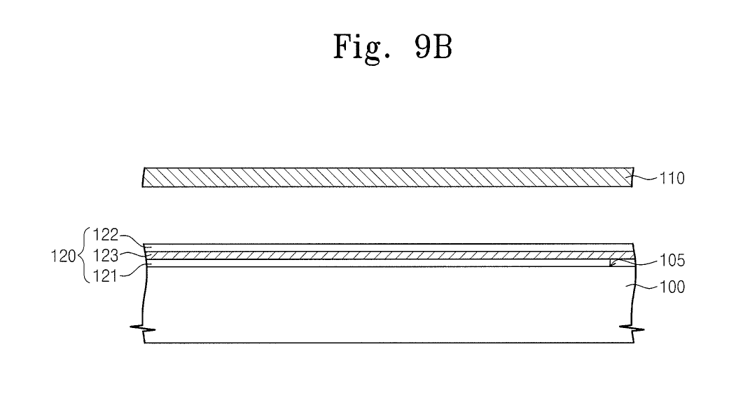

A method of manufacturing a display device according to still another embodiment will now be described with reference to FIGS. 9A, 9B, 10, and 11. FIGS. 9A, 9B, 10, and 11 illustrate schematic sectional views of stages in a method of manufacturing a display device and the display device fabricated thereby according to other embodiments. Hereinafter, a description of the same or about the same components as in the previous embodiments will not be repeated or will be briefly provided.

Referring to FIGS. 9A and 9B, an adhesive layer 120 may be provided between a display panel 100 and a polarization member 110. The adhesive layer 120 may include a first adhesive layer 121 (having a first adhesive material), a second adhesive layer 122 (having a second adhesive material), and a third adhesive layer 122 (interposed between the first and second adhesive layers 121 and 122). The first adhesive layer 121 may be formed on one surface of the third adhesive layer 122; and the second adhesive layer 122 may be formed on another surface of the third adhesive layer 122 so that a film-type adhesive layer 120 may be provided. The first adhesive material may be a material having predetermined adhesion strength. The adhesion strength of the first adhesive material measured at room temperature may be higher than the adhesion strength of the first adhesive material measured at a temperature higher than the room temperature. The first adhesive material may contain one of an acrylic copolymer and a modified rosin ester. The second adhesive material may be an adhesive material, the adhesion strength of which hardly varies according to temperature. For example, the second adhesive material may be an acrylic adhesive. Alternatively, the second adhesive material may be the same material as the first adhesive material. The third adhesive layer 122 may be a silicon-treated polyethylene terephthalate (PET) film.

Referring to FIG. 9A, the adhesive layer 120 may be adhered to the surface of the polarization member 110. The first adhesive layer 121 may be disposed facing the display panel 100, while the second adhesive layer 122 may be disposed facing the polarization member 110.

Referring to FIG. 9B, the adhesive layer 120 may be adhered onto an emission surface 105 of the display panel 100. The first adhesive layer 121 may be disposed facing the display panel 100, while the second adhesive layer 122 may be disposed facing the polarization member 110.

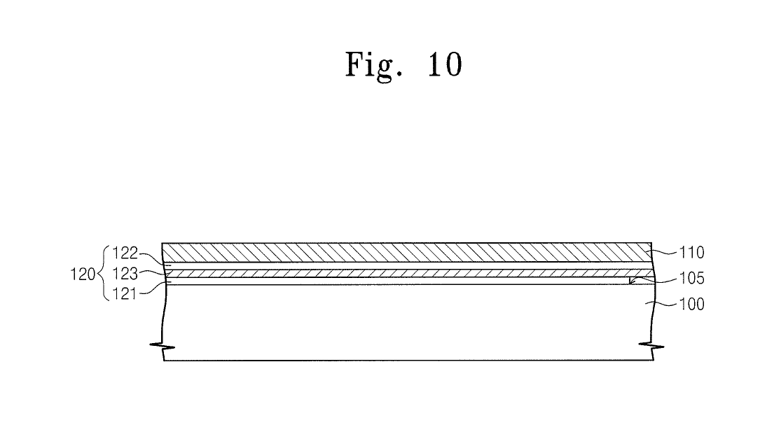

Referring to FIG. 10, the display panel 100 and the polarization member 110 may be adhered to each other using the adhesive layer 120. After the polarization member 110 is aligned with the display panel 100, the polarization member 110 may be adhered to the display panel 100.

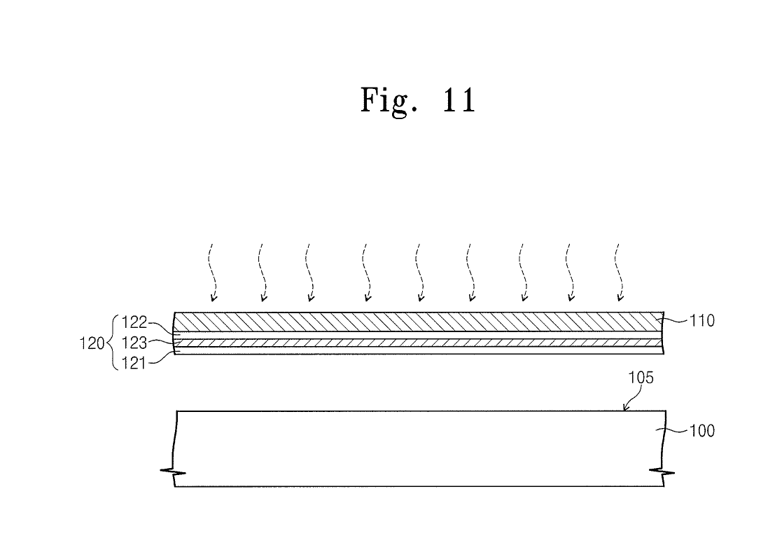

A rework process will now be described with reference to FIG. 11.

Referring to FIG. 11, the adhesive layer 120 may be heated up to a predetermined temperature. The temperature (hereinafter, heating temperature) may be higher than room temperature. Due to the heating step, the adhesion strength of the first adhesive layer 121 may be reduced. In this case, the adhesion strength of the second adhesive layer 122 may hardly or minutely vary according to temperature. Accordingly, damage to the display panel 100 may be prevented, and the polarization member 110 may be easily removed from the display panel 100.

A display device according to embodiments will now be described with reference to FIGS. 4, 7, and 10.

Referring to FIGS. 4, 7, and 10, the display device may include a display panel 100 and a polarization member 110 adhered onto an emission surface 105 of the display panel 100. An adhesive layer 120 may be interposed between the display panel 100 and the polarization member 110 so that the display panel 100 and the polarization member 110 can be adhered to each other by the adhesive layer 120.

Although not shown, the display device may include a driving device configured to drive the display panel 100 and a housing on which the display panel 100 and the driving device are mounted.

An adhesive layer 120 according to an embodiment will now be described with reference to FIG. 4. Referring to FIG. 4, the adhesive layer 120 may include a single layer having a first adhesive material. The first adhesive material may be a material having predetermined adhesion strength. The adhesion strength of the first adhesive material measured at room temperature may be higher than the adhesion strength of the first adhesive material measured at a temperature higher than the room temperature. The first adhesive material may contain an acrylic copolymer and modified rosin ester.

An adhesive layer 120 according to another embodiment will now be described with reference to FIG. 7. Referring to FIG. 7, the adhesive layer 120 may include a first adhesive layer 121 (having a first adhesive material) and a second adhesive layer 122 (having a second adhesive material). The first adhesive material may be the same as the first adhesive material of FIG. 4. The second adhesive material may be an adhesive material, the adhesion strength of which hardly varies according to temperature. For example, the second adhesive material may be an acrylic adhesive. The first adhesive layer 121 may contact the display panel 100, while the second adhesive layer 122 may contact the polarization member 110.

An adhesive layer 120 according to yet another embodiment will now be described with reference to FIG. 10. Referring to FIG. 10, the adhesive layer 120 may include a first adhesive layer 121 (having a first adhesive material), a second adhesive layer 122 (having a second adhesive material), and a third adhesive layer 122 (including a silicon-treated PET film). The third adhesive layer 122 may be interposed between the first and second adhesive layers 121 and 122. The first and second adhesive materials may be respectively the same as the first and second adhesive materials of FIG. 7. The first adhesive layer 121 may contact the display panel 100, while the second adhesive layer 122 may contact the polarization member 110.

By way of summation and review, manufacture of a display device involves several processes. Each of the processes is performed on the resultant structure on which the previous process was performed. Therefore, in the case that an error occurs in one process, the resultant structure on which the previous process was performed may be also damaged. As a result, process yield may be reduced. In the case of a high-definition and/or high resolution (HD) display device, process loss may be further increased due to the above-described error.

According to example embodiments, if an error occurs in adhering a polarization film to a display panel, the polarization film can be easily removed from a surface of a display panel during an operation of reworking the polarization film. Accordingly, failures, such as an unintended peeling of a thin encapsulation layer from the display panel, may be reduced. As a result, the yield of a process of manufacturing a display device may be increased.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or members described in connection with a particular embodiment may be used singly or in combination with features, characteristics, and/or members described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of manufacturing a display device, the method comprising:
providing an adhesive layer between a display panel and a first polarization member; and
adhering the display panel and the first polarization member to each other using the adhesive layer,
wherein the adhesive layer includes an adhesive material, the adhesive material having a first adhesion strength at a first temperature and a second adhesion strength at a second temperature, the second temperature being higher than the first temperature, and the first adhesion strength being higher than the second adhesion strength.

2. The method as claimed in claim 1, wherein providing the adhesive layer includes adhering the adhesive layer to a surface of the first polarization member that faces the display panel.

3. The method as claimed in claim 1, wherein providing the adhesive layer includes adhering the adhesive layer to a surface of the display panel that faces the first polarization member.

4. The method as claimed in claim 1, wherein the adhesive material includes one of an acrylic copolymer and a modified rosin ester.

5. The method as claimed in claim 4, wherein:
the adhesive layer includes a plurality of adhesive layers including a first adhesive layer that includes the adhesive material having the first adhesion strength at the first temperature and the second adhesion strength at the second temperature, and
adhering the display panel and the first polarization member to each other is carried out such that the first adhesive layer faces the display panel.

6. The method as claimed in claim 5, wherein the adhesive layer includes a second adhesive layer, the second adhesive layer including an acrylic adhesive.

7. The method as claimed in claim 6, wherein the adhesive layer includes a third adhesive layer, the third adhesive layer including a silicon-treated polyethylene terephthalate film.

8. The method as claimed in claim 7, wherein the first adhesive layer, second adhesive layer and the third adhesive layer are disposed such that the first adhesive layer faces the display panel, the second adhesive layer faces the first polarization member and the third adhesive layer is between the first adhesive layer and the second adhesive layer.

9. The method as claimed in claim 1, further comprising separating the first polarization member from the display panel by heating the adhesive layer up to the second temperature.

10. The method as claimed in claim 9, further including adhering the display panel and a second polarization member to each other using the adhesive material.

11. The method as claimed in claim 1, further comprising:
after adhering the display panel and the first polarization member to each other using the adhesive layer, determining whether the display panel and the first polarization member have been defectively adhered to each other, and
when the determining indicates that the display panel and the first polarization member have been defectively adhered to each other, separating the first polarization member from the display panel by heating the adhesive layer up to the second temperature and adhering the display panel and a second polarization member to each other using the adhesive material.

12. The method as claimed in claim 1, wherein the display panel has an encapsulation structure including at least one of an inorganic layer and an organic layer.

13. The method as claimed in claim 12, wherein the adhering of the display panel and the first polarization member to each other using the adhesive layer is carried out such that the adhesive layer faces the inorganic layer or organic layer of the encapsulation structure.

14. A display device, comprising:
a display panel;
a polarization member disposed on a surface of the display panel; and
an adhesive layer interposed between the display panel and the polarization member,
wherein the adhesive layer includes an adhesive material having a first adhesion strength at room temperature and a second adhesion strength at a temperature higher than the room temperature, and the first adhesion strength is higher than the second adhesion strength.

15. The display device as claimed in claim 14, wherein the adhesive material includes one of an acrylic copolymer and a modified rosin ester.

16. The display device as claimed in claim 15, wherein:
the adhesive layer includes a plurality of adhesive layers including a first adhesive layer that includes the adhesive material having the first adhesion strength at the first temperature and the second adhesion strength at the second temperature, and
the first adhesive layer faces the display panel.

17. The display device as claimed in claim 16, wherein the adhesive layer includes a second adhesive layer, the second adhesive layer including an acrylic adhesive.

18. The display device as claimed in claim 17, wherein the adhesive layer includes a third adhesive layer, the third adhesive layer including a silicon-treated polyethylene terephthalate film.

19. The display device as claimed in claim 18, wherein the first adhesive layer faces the display panel, the second adhesive layer faces the first polarization member and the third adhesive layer is between the first adhesive layer and the second adhesive layer.

20. The display device as claimed in claim 18, wherein the display panel has an encapsulation structure including at least one of an inorganic layer and an organic layer and the first adhesive layer faces the encapsulation structure.
